(19) United States
(12) Patent Application Publication
(10) Pub. No.: US 2019/0299823 A1
(43) Pub. Date: Oct. 3, 2019

(54) VEHICLE

(71) Applicant: MAZDA MOTOR CORPORATION, Hiroshima (JP)

(72) Inventor: Toshihiko TOMITA, Hiroshima-shi (JP)

(73) Assignee: MAZDA MOTOR CORPORATION, Hiroshima (JP)

(21) Appl. No.: 16/294,517

(22) Filed: Mar. 6, 2019

(30) Foreign Application Priority Data
Mar. 28, 2018 (JP) 2018-062598

(51) Int. Cl. B60N 2/30; B60N 2/68; B62D 25/20

(52) U.S. Cl. CPC B60N 2/3013; B62D 25/2036; B60N 2/68

(57) ABSTRACT

A vehicle comprises a ring-shaped structural portion which is provided over a floor portion, both side-face portions, and an upper-face portion of a vehicle body which constitute a cabin, having a closed cross section, and configured in a ring shape in a vehicle elevational view and a rear seat arranged in the cabin. The rear seat includes a seat cushion which is fixed to the floor portion and a seatback which is capable of falling down, in a vehicle longitudinal direction, relative to the seat cushion. The seatback is supported at a part (a support bracket) of the ring-shaped structural portion which corresponds to the side-face portion via a pivot so as to fall down.

### BACKGROUND OF THE INVENTION

The present invention relates to a vehicle, and in particular, to the vehicle which has a characterized attachment structure of a rear seat.

Japanese Patent Laid-Open Publication No. 2011-143883 discloses an example of the attachment structure of the rear seat. According to this patent document, the rear seat is attached onto a floor panel via support brackets. Specifically, a pair of front-and-rear cross members which extend in a vehicle width direction are provided on the floor panel, and support brackets are provided at the cross members, respectively. A seatback is supported at the support bracket provided at the rear cross member, and a seat cushion is supported at the support bracket provided at the front cross member. Herein, the seatback is supported at the support bracket via a pivot so as to fall down in a longitudinal direction around the pivot.

In recent designing of the vehicle, it has been developed to achieve improvement of the ride quality and suppression of car sickness by improving a sense of unity of an occupant and a vehicle, that is, by more matching a move of the vehicle which the occupant feels visually and a move of an occupant's body which the occupant feels through the seat. This kind of vehicle designing has recently focused on not only the front seat but the rear seat.

From a point of view of the above-described requirement, it has been considered that there is still room for improvement in the conventional attachment structure of the rear seat where the rear seat is attached onto the floor panel, which is disclosed in the above-described patent document.

### SUMMARY OF THE INVENTION

The present invention has been devised in view of the above-described matter, and an object of the present invention is to provide a vehicle with a seat attachment structure which can improve the sense of unity of the occupant seated in the rear seat and the vehicle.

The present invention is a vehicle, comprising a ring-shaped structural portion provided over a floor portion, both side-face portions, and an upper-face portion of a vehicle body which constitute a cabin, having a closed cross section, and configured in a ring shape in a vehicle elevational view, and a rear seat arranged in the cabin, wherein the rear seat includes a seat cushion fixed to the floor portion and a seatback capable of falling down, in a vehicle longitudinal direction, relative to the seat cushion, and the seatback is supported at a part of the ring-shaped structural portion which corresponds to the side-face portion via a pivot so as to fall down.

The above-described ring-shaped structural portion having the closed cross section of the present invention has a higher rigidity than the other part of the vehicle body. Therefore, according to the above-described vehicle structure where the seatback is supported at the part of the ring-shaped structural portion corresponding to the side-face portion via the pivot, the rear seat is so easily interlinked with the move of the vehicle body that the sense of unity of the occupant seated in the rear seat and the vehicle can be improved.

In an embodiment of the present invention, the ring-shaped structural portion includes a ring-shaped body part which is configured in the ring shape in the vehicle elevational view and an extension part which extends in a branch shape from the ring-shaped body part, and the seatback is supported at the extension part via the pivot.

According to this structure, since the pivot is supported at the extension part connected to the ring-shaped body part, the above-described operation/effect of the present invention can be obtained even in a case where the pivot is positioned differently from the ring-shaped body part which is a main part of the ring-shaped structural portion.

In another embodiment of the present invention, the above-described extension part includes a closed cross-section forming member which is fixed to the side face portion and connected to the ring-shaped body part, and a closed cross section is formed by the closed cross-section forming member and the side face portion.

According to this structure, since the closed cross section of the extension part is formed by using a part of the side-face portion of the vehicle body, weight reduction of the vehicle body can be achieved.

In another embodiment of the present invention, the seatback is a split-type falling-down seatback comprising a right seatback portion and a left seatback portion, and one end, in a vehicle width direction, of each of the right-and-left seatback portions is supported at the part of the ring-shaped structural portion corresponding to the side-face portion via the pivot and the other end of each of the right-and-left seatback portions is supported at an attaching member which is fixed to a part of the ring-shaped structural portion which corresponds to the floor portion via another pivot.

According to this structure where each of the right-and-left seatback portions is supported at the part of the ring-shaped structural portion corresponding to the side-face portion and the part of the ring-shaped structural portion corresponding to the floor portion such that the seatback portion extends between these parts, the sense of unity of the occupant seated in each of the right-and-left split rear seats and the vehicle can be further improved.

In another embodiment of the present invention, the seat attachment structure further comprises a shaft-shaped reinforcing member which extends over the parts of the ring-shaped structural portion which correspond to right-and-left side-face portions of the cabin and interconnects the attaching members.

According to this structure, the rear seat can be interlinked with the move of the vehicle body more highly.

In another embodiment of the present invention, the seat attachment structure further comprises an engaging device which is configured to make the seatback be engaged with and disengaged from the part of the ring-shaped structural portion corresponding to the side face portion.

According to this structure, the seatback is connected to the ring-shaped structural portion by means of the engaging device separately from the pivot. Thereby, the rear seat can be interlinked with the move of the vehicle body more highly.

Other features, aspects, and advantages of the present invention will become apparent from the following description which refers to the accompanying drawings.

### BRIEF DESCRIPTION OF THE DRAWINGS

FIG. 1 is a perspective view of an inside of a vehicle (vehicle body) of the present invention.

FIG. 2 is a perspective view of the inside of the vehicle body (in a state where a rear seat is removed).

FIG. 3 is a sectional view of the vehicle body (a sectional view taken along line of FIG. 4).

FIG. 4 is a sectional view of the vehicle body (a sectional view taken along line IV-IV of FIG. 3).

FIG. 5 is a perspective view of a major part of the inside of the vehicle, which shows an attachment structure of the rear seat.

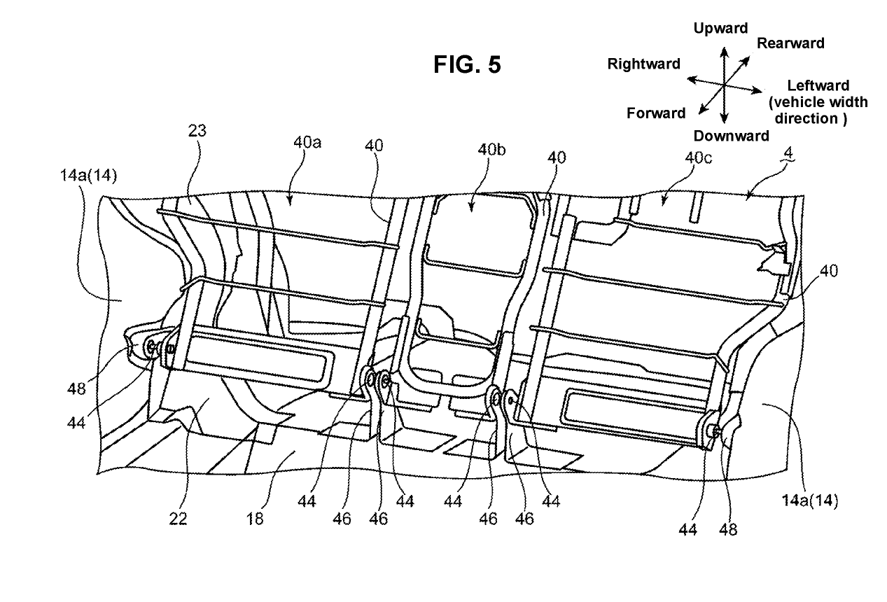

FIG. 6 is a sectional view of the vehicle body (a sectional view taken along line VI-VI of FIG. 4).

FIG. 7 is an elevational view of the inside of the vehicle (vehicle body) according to a modified example.

### DETAILED DESCRIPTION OF THE INVENTION

Hereafter, an embodiment of the present invention will be specifically described referring to the drawings.

[Seat Attachment Structure]

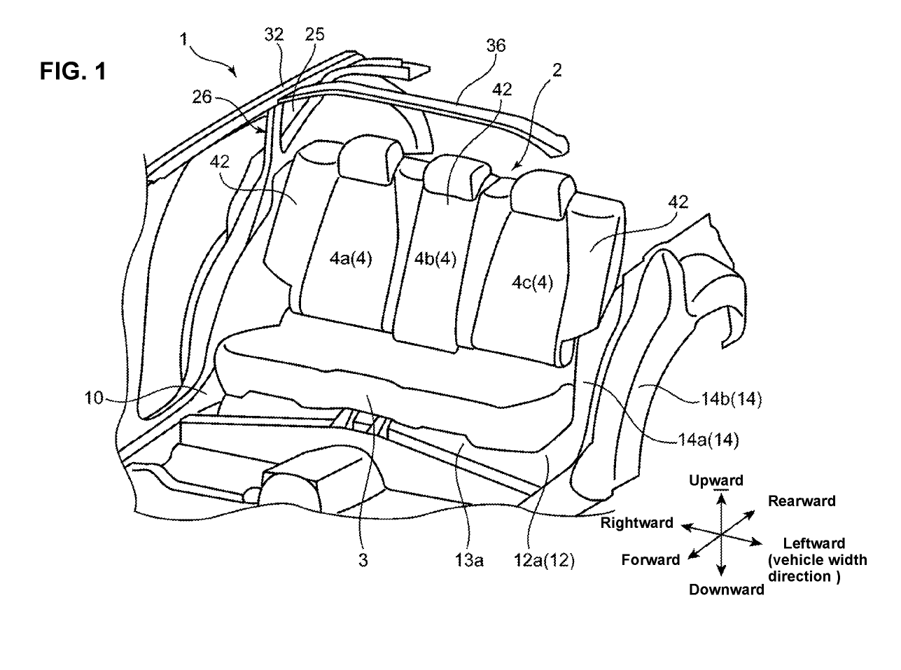

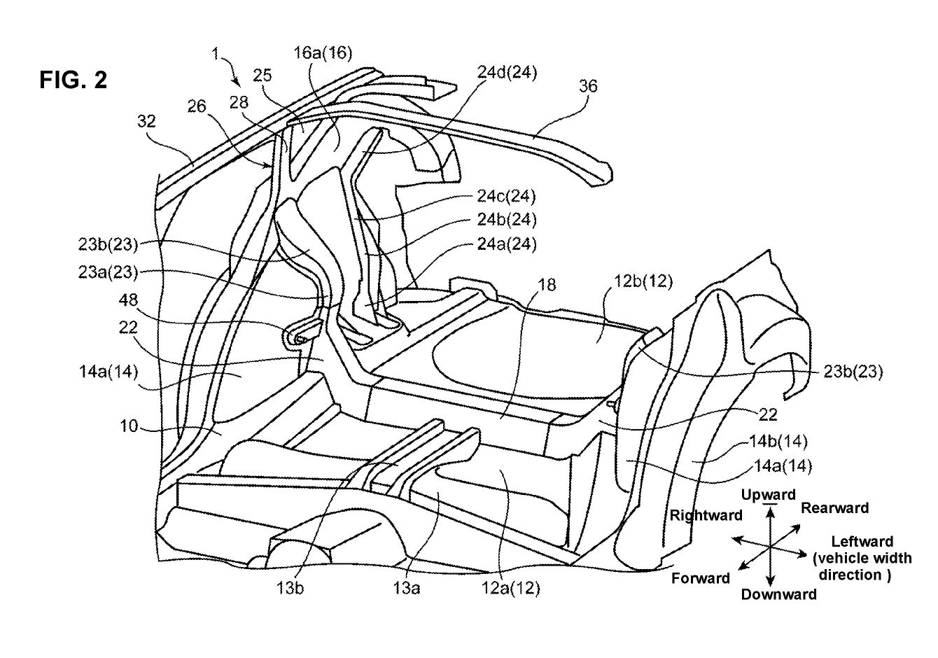

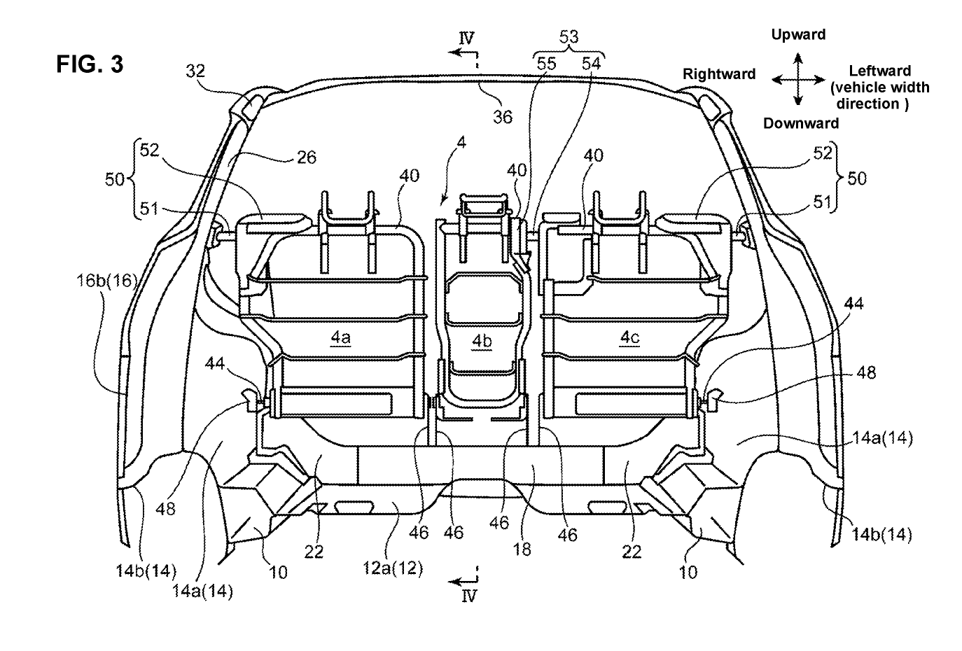

FIG. 1 is a perspective view of an inside of a vehicle (vehicle body) according to an embodiment of the present invention, FIG. 2 is a perspective view of the inside of the vehicle body, and FIG. 3 is a sectional view of the vehicle body. In the figures, directional indications (“frontward,” “rearward,” “leftward,” “rightward,” “upward” and “downward”) are based on the vehicle, and the directions used in the following description should be based on these indications unless there is any particular referring.

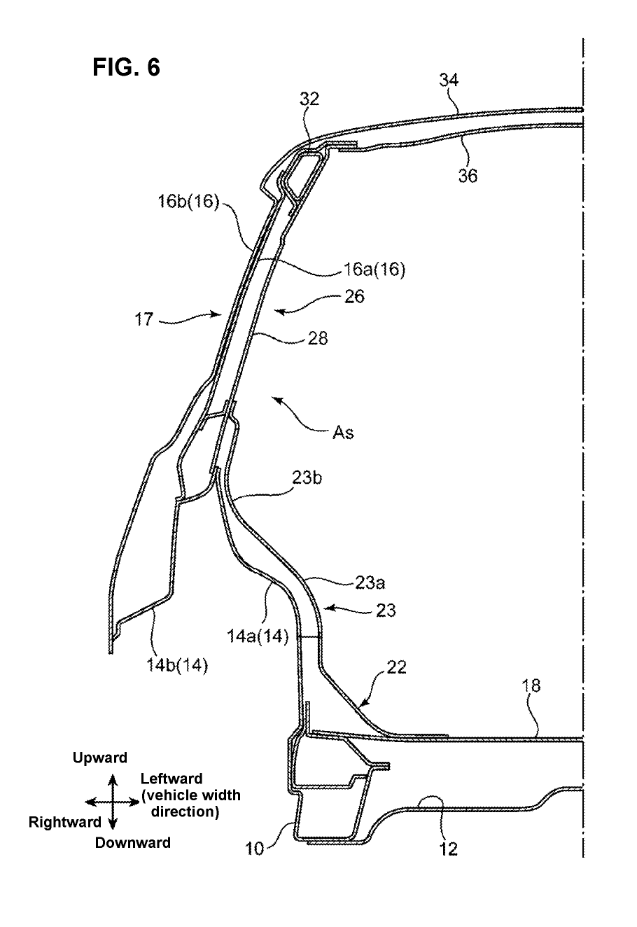

The vehicle shown in the figures is a hatchback type of automotive vehicle equipped with two row seats, and a front seat (not illustrated) and a rear seat 2 are provided in a cabin of a vehicle body 1. As shown in FIGS. 1-3, the vehicle body 1 comprises a pair of right-and-left rear side frames 10, a floor panel 12 which is provided to extend between the rear side frames 10 and constitutes a floor portion of the cabin, wheel houses 14 and side panels 16 which constitute right-and-left side-face portions of the cabin, and a roof panel 34 (see FIG. 6) which constitutes an upper-face portion of the cabin. The pair of rear side frames 10 are respectively connected to right-and-left front side frames, not illustrated.

The floor panel 12 comprises a front floor panel 12a which constitutes a floor surface positioned in front of an area where the rear seat 2 is provided, a kick-up panel 12b which extends upwardly and rearwardly from a rear end of the front floor panel 12a, and a rear floor panel 12c which is provided to extend rearwardly from a rear end of the kick-up panel 12b and constitutes a floor face of a baggage compartment primarily. A recess portion which is recessed downwardly for accommodating a spare tire is formed at an upper face of the rear floor panel 12c.

A cross member 18 which extends in a vehicle width direction (a lateral direction) between the right-and-left rear side frames 10 is provided at a portion of an upper face of the floor panel 12 which corresponds to the kick-up panel 12b. The cross member 18 is configured to have a roughly hat-shaped cross section, and forms a closed cross section extending in the vehicle width direction together with the floor panel 12.

Suspension housings 22 are provided continuously at right-and-left both ends of the cross member 18, respectively. As shown in FIGS. 2 and 3, the suspension housing 22 is configured to have a roughly L shape, in an elevational view, such that it extends in the vehicle width direction along the cross member 18 and extends upwardly along the wheel house 14 by way of an upper face of the rear side frame 10. A front side brace 23 is further provided continuously at an upper end portion of the suspension housing 22. The front side brace 23 comprises a brace lower portion 23a which is continuous to an upper end of the suspension housing 22 and extends upwardly along a curved portion of the wheel house 14 and a brace upper portion 23b which is continuous to an upper end of the brace lower portion 23a and extends along the wheel house 14 to a position of a lower end portion of a rear pillar 26, which will be described later.

The suspension housing 22 and the front side brace 23 are respectively configured to have a roughly hat-shaped cross section, and cooperates with the wheel house 14 and the like to form a closed cross section which extends in a vertical direction along the side-face portion of the cabin.

A rear side brace 24 is further provided in back of the front side brace 23. The rear side brace 24 comprises a brace lower portion 24a which is configured in a roughly L shape, in the elevation view, and extends upwardly along the wheel house 14 from a position located near a rear end portion of the rear side frame 10, a first middle portion 24b which is continuous to an upper end of the brace lower portion 24a and extends upwardly along the curved portion of the wheel house 14, a second middle portion 24c which is continuous to an upper end of the first middle portion 24b and extends upwardly along the wheel house 14, and a brace upper portion 24d which extends upwardly from an upper end portion of the wheel house 14 along a side panel 16. The rear side brace 24 is configured to have a roughly hat-shaped cross section similarly to the front side brace 23, and cooperates with the wheel house 14 and the side panel 16 to form a closed cross section extending in the vertical direction along the side-face portion of the cabin (the baggage compartment, mainly).

Herein, as shown in FIG. 6, the wheel house 14 comprises a wheel house inner 14a which is positioned on the side of the cabin and a wheel house outer 14b which is provided on the outside of the wheel house inner 14a and protrudes outwardly in the vehicle width direction. Further, the side panel 16 comprises a side panel inner 16a which is positioned on the side of the cabin and a side panel outer 16b which is provided on the outside of the side panel inner 16a, and an upper end portion of the wheel house inner 14a is connected to the side panel inner 16a. Accordingly, respective portions of the suspension housing 22 and the respective side braces 22, 24 which correspond to the wheel house 14 are provided along the wheel house inner 14a, and respective portions of the suspension housing 22 and the respective side braces 22, 24 which correspond to the side panel 16 are provided along the side panel inner 16a.

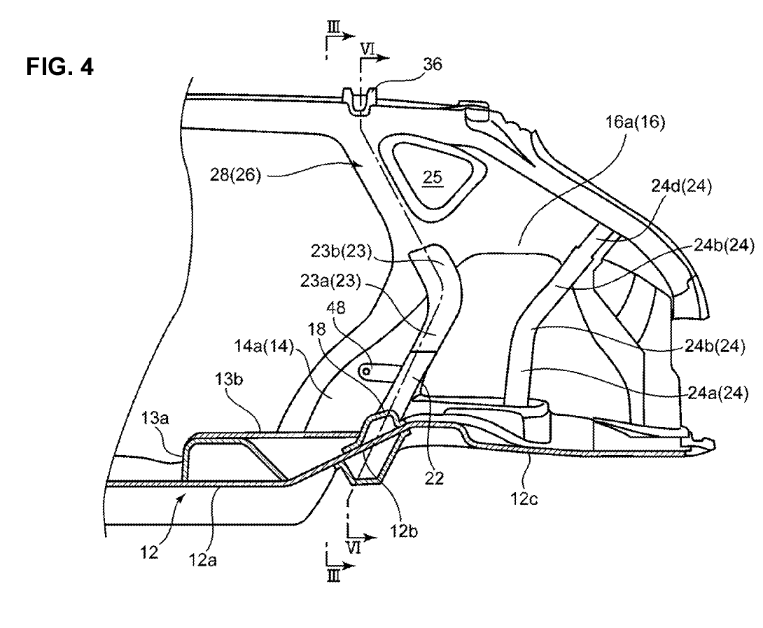

As shown in FIGS. 2 and 4, the rear pillar 26 is provided above the wheel house 14 and a quarter-window opening 25 is provided at a portion of the side panel 16 which is positioned in back of the rear pillar 26.

The rear pillar 26 comprises, as shown in FIG. 6, a pillar portion 17 which is provided at the side panel 16 and a pillar inner 28 which is joined to a cabin-side side face of the pillar portion 17. The pillar inner 28 is configured to have a roughly hat-shaped cross section, and cooperates with the pillar portion 17 to form a closed cross section which extends from the upper portion of the wheel house 14 to the upper-face portion of the cabin along the side-face portion of the cabin.

Herein, a lower end portion of the pillar inner 28 extends downwardly below a lower end portion of the pillar portion 17 along the side panel inner 16a, and partially overlaps an upper end portion of the front side brace 23. Accordingly, a closed cross-section portion which the front side brace 23 forms and a closed cross-section portion which the pillar inner 28 forms overlap each other partially.

In FIG. 6, reference character 32 denotes a roof side rail, reference character 34 denotes a roof panel, and as shown in this figure, an upper end portion of the pillar inner 28 is connected to the roof side rail 32.

A roof reinforcement 36 which extends in the vehicle width direction from a position corresponding to the upper end portion of the pillar inner 28 is provided at a lower face of the roof panel 34. The roof reinforcement 36 is configured to have a roughly hat-shaped cross section, and cooperates with the roof panel 34 to form a closed cross section extending in the vehicle width direction along the upper-face portion of the cabin.

Herein, the vehicle body 1 is configured such that the floor portion of the vehicle body 1 is constituted by the floor panel 12, the right-and-left side-face portions of the vehicle body 1 are constituted by the wheel houses 14 (the wheel house inners 14a) and the side panels 16 (the side panel inners 16a), and the upper-face portion of the vehicle body 1 is constituted by the roof panel 34. The closed cross-section portion which is formed by the cross member 18 at the floor portion, the closed cross-section portions which are formed by the suspension housings 22, the front side braces 23 and the pillar inners 28 at the right-and-left side-face portions, and the closed cross-section portion which is formed by the roof reinforcement 36 at the upper-face portion are provided continuously. That is, the vehicle body 1 is provided with a ring-shaped structural portion As which is continuously provided over the floor portion, the side-face portions, and the upper-face portion, having the closed cross section, and configured in a ring shape in the vehicle elevational view.

Next, the rear seat 2 and its attachment structure will be described.

As shown in FIGS. 1 and 3, the rear seat 2 is a bench type seat for three occupants. The rear seat 2 comprises a seat cushion 3 and a seatback 4 which is equipped with a headrest and capable of falling down in the longitudinal direction. In FIG. 3, only a frame portion of the seatback 4 of the rear seat 2 is illustrated.

The seatback 4 is a so-called split-type falling-down seatback comprising a right seatback portion 4a, a center seatback portion 4b, and a left seatback portion 4c, having a split ratio of 4:2:4 in the vehicle width direction. A space of the baggage compartment can be enlarged according to a user's preference by selectively pulling forwardly down (folding) the three seatback portions 4a-4c. Herein, the central seatback portion 4b serves as an armrest for right-and-left occupants in a state where it is folded forwardly.

Each of the seatback portions 4a-4c comprises a seatback frame 40, a cushion material 42 which covers the seatback frame 40, and others.

The seatback frame 40 is made of a metal-made pipe material or the like and has a roughly rectangular shape in the elevational view. A pair of pivots 44 which extend in the vehicle width direction are provided at the right-and-left both side-face portions of lower end portions of the seatback frames 40, and the seatback frames 40 are supported at the vehicle body 1 via the pivots 44 so as to fall down (swing).

The right-and-left pivots 44 of the central seatback portion 4b are supported at respective support brackets 46 which are fixed to an upper face of the cross member 18. Accordingly, the seatback 4b is supported at the cross member 18.

Meanwhile, the left-side pivot 44 (which corresponds to “another pivot” in claims of the present invention) of the pivots 44 for the right seatback portion 4a is supported at the support bracket 46 which is fixed to the upper face of the cross member 18 similarly to the central seatback portion 4b. However, the right-side pivot 44 (which corresponds to “a pivot” in claims of the present invention) is supported at a support bracket 48 which is fixed to the wheel house inner 14a. These structures for the left seatback portion 4c are similar except being different bilaterally. Accordingly, the right-and-left seatback portions 4a, 4c are supported at the cross member 18 and the wheel house inners 14a such that these seatback portions 4a, 4d extend between the cross member 18 and the wheel house inner 14a.

The support bracket 48 fixed to the wheel house inner 14a is configured in a roughly dome shape such that its cross section is roughly hat-shaped, and cooperates with the wheel house inner 14a to form a closed cross section at the side-face portion of the cabin. The support bracket 48 extends in the longitudinal direction and is integrally joined to the suspension housing by welding or the like at its rear end portion as shown in FIGS. 2 and 4. That is, the closed cross-section portions which are formed by the support brackets 48 and the closed cross-section portions which are formed by the suspension housings 22 are provided continuously, so that the closed cross-section portions which are formed by the support brackets 48 constitute a part of the above-described ring-shaped structural portion As.

In the present embodiment, the support bracket 48 corresponds to a “closed cross-section forming member” in claims of the present invention. Further, the closed cross-section portion of the ring-shaped structural portion As which is formed by the support bracket 48 corresponds to an “extension part” in claims of the present invention, and the other part of the ring-shaped structural portion As corresponds to a “ring-shaped body part” in claims of the present invention.

Meanwhile, the support bracket 46 which is fixed to the cross member 18 is configured in an L shape in the elevational view, which comprises a fixation portion which is provided along the upper face of the cross member 18 and a support portion which extends upwardly from one end of the fixation portion and supports the pivot 44. This support bracket 46 is fixed to the cross member 18 by fixing means, such as welding or bolts and nuts.

Herein, as shown in FIG. 3, the vehicle is provided with a first engaging device 50 to make the right-and-left seatback portions 4a, 4c be engaged with the vehicle body 1 and a second engaging device 53 to make the central seatback portion 4b be engaged with the left seatback portion 4c.

The first engaging device 50 comprises a vehicle-body-side hook portion 51 which is provided at an upper portion (a brace upper portion 23b) of the front side brace 23, a seat-side hook portion 52 which is engaged with and disengaged from the vehicle-body-side hook portion 51, a releasing mechanism to release this engaging, and others. That is, the right-and-left seatback portions 4a, 4c can be held in their upright positions (standing positions) so that the occupants can be seated therein when the seat-side hook portion 52 is engaged with the vehicle-body-side hook portion 51, whereas these seatback portions 4a, 4a can fall down forwardly when this engaging is released.

The second engaging device 53 includes a left seat hook portion 55 which is provided at the left seatback portion 4c, a central seat hook portion 54 which is provided at the central seatback portion 4b and engaged with and disengaged from the left seat hook portion 55, a releasing mechanism to release this engaging, and others. That is, the both seatback portions 4b, 4c are integrally connected when the central seat hook portion 54 is engaged with the left seat hook portion 55, whereby the both seatback portions 4b, 4c can be made to fall down integrally. When the engaging is released, only the central seatback portion 4b is made to fall down so that it can be used as an armrest.

Meanwhile, the seat cushion 3 is fixed onto the front floor panel 12a positioned in front of the cross member 18 via a hinge or the like. As shown in FIG. 2, a protrusion portion 13a which protrudes toward the cabin (upwardly) and extends in the vehicle width direction between the right-and-left rear side frames 10 is formed at the front floor panel 12a, and a floor reinforcement 13b which extends in the longitudinal direction is fixed onto a central portion, in the vehicle width direction, of an upper face of the front floor panel 12a. Further, the seat cushion 3 is fixed onto the front floor panel 12a in a state where the seat cushion 3 extends over the protrusion portion 13a, the floor reinforcement 13b, and the right-and-left rear side frames 10, which is not illustrated.

### Operation/Effect

As described above, the vehicle body 1 comprises the ring-shaped structural portion As having the closed cross section which is provided over the floor portion, the side-face portions, and the upper-face portion which constitute the cabin, and the seatback 4 of the rear seat 2 is supported at this ring-shaped structural portion As. According to the structure of the vehicle body 1, since the ring-shaped structural portion As having the closed cross section has the high rigidity, the seatback 4 supported at the ring-shaped structural portion As is easily interlinked with the move of the vehicle body 1. In particular, since the right-and-left seatback portions 4a, 4c are supported at the parts of the ring-shaped structural portion As which correspond to the side-face portions of the vehicle body 1 (i.e., the support brackets 48 fixed to the wheel houses 14) and the parts of the ring-shaped structural portion As which correspond to the floor portion of the vehicle body 1 (i.e., the cross member 18) such that these seatback portions 4a, 4c extend between these parts, the seatback 4 is easily interlinked with the move of the vehicle body 1 longitudinally and laterally. According to the above-described structure, the sense of unity of the occupant seated in the rear seat 2 and the vehicle can be further improved, compared to the conventional structure where the seatback is supported only at the cross member provided on the floor portion.

Further, each of the right-and-left seatback portions 4a, 4c is held in its upright position (standing position) by the first engaging device 50 when the occupant is seated. In this case, each of the seatback portions 4a, 4c is engaged with the vehicle-body-side hook portion 51 fixed to the upper portion (the brace upper portion 23b) of the front side brace 23 by means of the seat-side hook portion 52. That is, each of the right-and-left seatback portions 4a, 4c is supported at the part of the ring-shaped structural portion As which corresponds to the side-face portion of the vehicle at the upper-and-lower two points (the position of the pivot 44 and the position of the seat-side hook portion 52). According to this seat attachment structure, the rear seat 2 is more easily interlinked with the move of the vehicle body 1, compared to a case where the vehicle-body-side hook portion 51 is provided at another position than the ring-shaped structural portion As. Thereby, the sense of unity of the occupant seated in the rear seat 2 and the vehicle can be improved as well.

Further, the central seatback portion 4b is supported at the part of the ring-shaped structural portion As which corresponds to the side-face portion of the vehicle body 1 (i.e., at the support bracket 48 fixed to the wheel house 14) via the left setback portion 4c when the central seatback portion 4b is connected to the left seatback portion 4c by means of the second engaging device 53. Thereby, the central seatback portion 4b is easily interlinked with the move of the vehicle body 1, so that the sense of unity of the occupant seated in the center of the rear seat 2 and the vehicle can be improved as well.

The present invention should not be limited to the above-described embodiment and any other modifications or improvements may be applied within the scope of a spirit of the present invention. For example, the following structures are applicable.

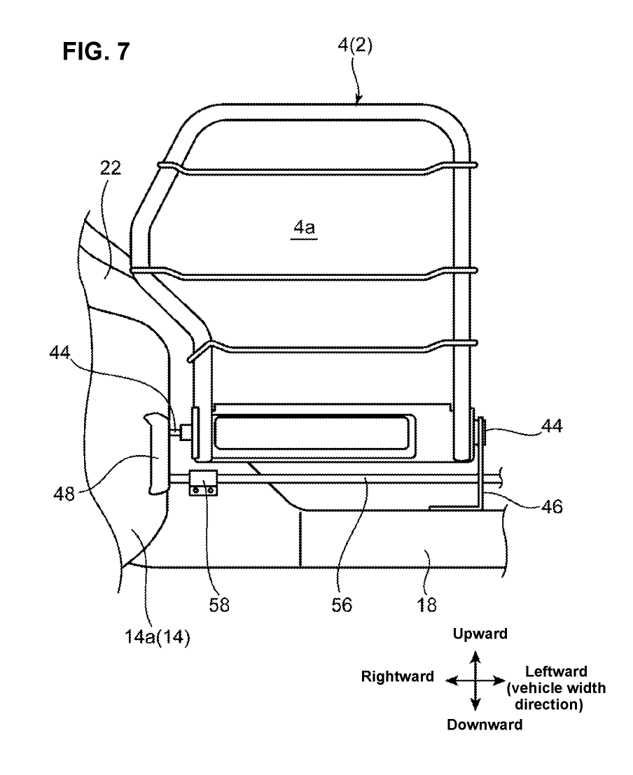

(1) The support brackets 46 which support the respective seatback portions 4a-4c at the cross member 18 may be interconnected by a reinforcing member 56 as shown in FIG. 7. In this example, the reinforcing member 56 is constituted by a metal-made or synthetic resin-made pipe member that extends in the vehicle width direction and fixed to the support brackets 46 in a state where the reinforcing member 56 penetrates the support brackets 46. Both ends of the reinforcing member 56 are supported at the parts of the ring-shaped structural portion As which correspond to the side-face portions of the vehicle body 1 (the support brackets 48 fixed to the wheel houses 14 in this example). Further, the reinforcing member 56 may be fixed to the part of the ring-shaped structural portion As which corresponds to the floor portion, and in this example, the reinforcing member 56 is fixed to a front face of the suspension housing 22 via a bracket 58.

According to the above-described structure in which the support brackets 46 supporting the seatback portions 4a-4c are connected to the parts of the ring-shaped structural portions As which correspond to the side-face portions of the vehicle body 1 via the reinforcing member 56, the unity of the seatback 4 and the vehicle body 1 is further improved. Accordingly, the sense of the unity of the occupant seated in the rear seat 2 and the vehicle can be further improved.

(2) The right-and-left seatback portions 4a, 4c are supported at the support brackets 48 fixed to the wheel house inners 14a via the pivots 44 in the above-described embodiment. However, if possible from a layout perspective, the pivots 44 may be directly supported at the suspension housings 22 and the front side braces 23.

Further, the pivot 44 may be supported at a portion which is provided at a side face of the suspension housing 22 and protrudes forwardly in a branch shape, for example. In this case, the portion protruding forwardly in the branch shape of the ring-shaped structural portion As corresponds to the “extension part” in claims of the present invention, and the other portion corresponds to the “ring-shaped body part” in claims of the present invention.

(3) While the central seatback portion 4b and the left seatback portion 4c are interconnected by the second engaging device 53 in the above-described embodiment, an engaging device capable of connecting the central seatback portion 4b and the right seatback portion 4a may be further provided. According to this structure, the respective seatback portions 4a-4c are integrally supported at the parts of the ring-shaped structural portion As which correspond to the side-face portions of the vehicle body 1. Accordingly, the unity of the seatback 4 and the vehicle body 1 is further improved, so that the sense of the unity of the occupant seated in the rear seat 2 and the vehicle can be further improved.

(4) The pivots 44 are provided at the seatback portions 4a-4c, respectively, and the seatback portions 4a-4c are supported at the vehicle 1 separately in the above-described embodiment. However, these pivots 44 are configured to be common to the seatback portions 4a-4c, for example. That is, the pivot may be made of a common pipe member which extends between the parts of the ring-shaped structural portion As which correspond to the right-and-left side-face portions of the vehicle body 1, and the seatback frames 40 of the seatback portions 4a-4c may be supported at this pivot so as to fall down (swing). According to this structure, the unity of the seatback 4 and the vehicle body 1 can be improved, so that the sense of the unity of the occupant seated in the rear seat 2 and the vehicle can be further improved.

What is claimed is:

1. A vehicle, comprising:
a ring-shaped structural portion provided over a floor portion, both side-face portions, and an upper-face portion of a vehicle body which constitute a cabin, having a closed cross section, and configured in a ring shape in a vehicle elevational view; and
a rear seat arranged in the cabin,
wherein said rear seat includes a seat cushion fixed to said floor portion and a seatback capable of falling down, in a vehicle longitudinal direction, relative to the seat cushion, and
said seatback is supported at a part of said ring-shaped structural portion which corresponds to said side-face portion via a pivot so as to fall down.

2. The vehicle of claim 1, wherein said ring-shaped structural portion includes a ring-shaped body part which is configured in the ring shape in the vehicle elevational view and an extension part which extends in a branch shape from said ring-shaped body part, and said seatback is supported at said extension part via the pivot.

3. The vehicle of claim 2, wherein said extension part includes a closed cross-section forming member which is fixed to said side face portion and connected to said ring-shaped body part, and a closed cross section is formed by said closed cross-section forming member and said side face portion.

4. The vehicle of claim 1, wherein said seatback is a split-type falling-down seatback comprising a right seatback portion and a left seatback portion, and one end, in a vehicle width direction, of each of said right-and-left seatback portions is supported at said part of the ring-shaped structural portion corresponding to the side-face portion via said pivot and the other end of each of said right-and-left seatback portions is supported at an attaching member which is fixed to a part of the ring-shaped structural portion which corresponds to said floor portion via another pivot.

5. The vehicle of claim 2, wherein said seatback is a split-type falling-down seatback comprising a right seatback portion and a left seatback portion, and one end, in a vehicle width direction, of each of said right-and-left seatback portions is supported at said part of the ring-shaped structural portion corresponding to the side-face portion via said pivot and the other end of each of said right-and-left seatback portions is supported at an attaching member which is fixed to a part of the ring-shaped structural portion which corresponds to said floor portion via another pivot.

6. The vehicle of claim 3, wherein said seatback is a split-type falling-down seatback comprising a right seatback portion and a left seatback portion, and one end, in a vehicle width direction, of each of said right-and-left seatback portions is supported at said part of the ring-shaped structural portion corresponding to the side-face portion via said pivot and the other end of each of said right-and-left seatback portions is supported at an attaching member which is fixed to a part of the ring-shaped structural portion which corresponds to said floor portion via another pivot.

7. The vehicle of claim 4, further comprising a shaft-shaped reinforcing member which extends over the parts of said ring-shaped structural portion which correspond to right-and-left side-face portions of the cabin and interconnects said attaching members.

8. The vehicle of claim 5, further comprising a shaft-shaped reinforcing member which extends over the parts of said ring-shaped structural portion which correspond to right-and-left side-face portions of the cabin and interconnects said attaching members.

9. The vehicle of claim 6, further comprising a shaft-shaped reinforcing member which extends over the parts of said ring-shaped structural portion which correspond to right-and-left side-face portions of the cabin and interconnects said attaching members.

10. The vehicle of claim 1, further comprising an engaging device which is configured to make said seatback be engaged with and disengaged from said part of the ring-shaped structural portion corresponding to the side face portion.
